(19) United States
(12) Patent Application Publication
(10) Pub. No.: US 2001/0038635 A1
(43) Pub. Date: Nov. 8, 2001

(54) Local area network (LAN) packet switch remote power system

(76) Inventor: Steven A. Rogers, Alton, NH (US)

Correspondence Address: WEINGARTEN, SCHURGIN, GAGNEBIN, & HAYES, LLP, TEN POST OFFICE SQUARE, BOSTON, MA, 02109, US

(21) Appl. No.: 09/755,962

(22) Filed: Jan. 5, 2001

Related U.S. Application Data
(60) Provisional application No. 60/174,674, filed on Jan. 6, 2000.

(51) Int. Cl. H04L 12/28

(52) U.S. Cl. 370/419

(57) ABSTRACT

A system for providing power to telephone handsets and other appliances that are connected to a LAN switch. Telephone handsets with built-in Ethernet interfaces can be used to create an enterprise voice communications network which emulates the functions of a standard voice private branch exchange (PBX) switch. The disclosed LAN switch advantageously provides power directly to LAN telephone instruments within the system. The disclosed system may include a means for adding a power system to an existing LAN switch so that remote telephone handsets can receive power from a central location. Alternatively, power equipment may be integrated into a LAN switch itself. The primary benefit of a central power system for Ethernet appliances is that is more convenient to provide back-up power, so that the attached appliances can continue to operate in the event of a power failure. The present system has significant benefits over the most popular current approach, which requires a backup power supply at each telephone instrument or other LAN appliance.

### CROSS REFERENCE TO RELATED APPLICATIONS

This application claims priority under 35USC §119(e) to provisional application Ser. No. 60/174,674, entitled “LOCAL AREA NETWORK (LAN) PACKET SWITCH REMOTE POWER SYSTEM”, and filed Jan. 6, 2000.

### STATEMENT REGARDING FEDERALLY SPONSORED RESEARCH OR DEVELOPMENT

N/A

### BACKGROUND OF THE INVENTION

The present invention relates generally to the provision of power to individual telephone instruments and appliances when connected to an Ethernet LAN (Local Area Network) switch, and more specifically to a local area network (LAN) packet switch remote power system.

As illustrated in FIGS. 2(a)-(c), existing telephone systems for business use normally consist of a central switch or Private Branch exchange (PBX) 14, which connects to telephones throughout the business via twisted pair wire shown as the station cable 17 and multipair cable 16. In most cases the PBX 14 uses a single or dual twisted pair cable, shown as the station cable 17 in FIG. 2(a), to connect with the telephone instrument. The telephone handset 11 and telephone handset 12 in FIG. 2(a) are illustrative telephone instruments. The PBX 14 sends signals to the telephone instruments 11 and 12 via a frequency translated modem system, which operates according to the frequency plan shown in FIG. 2 (b). The telephone instruments 11 and 12 send signals to the PBX 14 using a similar technique. In order to avoid interference, the signals from the PBX 14 may occupy a different frequency spectrum than the signals from the telephone instruments 11 and 12. Alternatively, transmit and receive signals may occupy the same spectrum envelope 18 shown in FIG. 2(b). If the transmit and receive signals occupy the same spectrum, a technique called adaptive echo cancellation is used at each end to enable both the PBX 14 and the telephone handsets 11 and 12 to discriminate between their transmitted data and their received data.

In either of the above existing approaches, the spectrum occupied by the telephone devices does not extend to zero frequency or direct current (“DC”). It is therefore possible to place a DC signal on the single twisted pair, from the PBX 14, to the telephone instruments 11 and 12. This DC signal can be used to power the telephone instruments 11 and 12. The DC signal does not interfere with telephone signaling as there is a di-plexing filter at each end. This type of existing system is further illustrated in FIG. 2(c). The di-plexing filter consists of Hi-pass 23 and Lo-pass 24 elements. The Hi-pass 23 and Lo-pass 24 elements permit the DC signal and the transmit and receive signals to be summed on the twisted pair wire leading from the PBX 14 to the telephone instruments 11 and 12. Also, the di-plexing filter prevents the DC power from entering the sensitive signaling circuitry, on either end. An Adaptive Echo Canceller, shown as AEC 19 and 20 in FIG. 2(c), is used at either end to prevent transmit data from interfering with receive data, since often they both occupy the same spectrum envelope 18.

DC Power 22 enters the cable via the Low-Pass Element 24. The DC Power 22 power is conducted to the appliance or telephone and then conducted through another Lo-Pass Element 24 to the Telephone DC-DC Converter 21 within the appliance or telephone. The output of the DC-DC Converter 21 can then be used to power the telephone instrument.

A technique for creating a “virtual” PBX is becoming popular in existing systems. In existing systems using this technique, the telephone instruments use an Ethernet cable, instead of a single twisted pair cable, to communicate with the PBX. In such systems, the PBX is a server with switch control software that is connected to the LAN, and the telephones are Ethernet devices that also communicate over the LAN. The advantage of this type of architecture, referred to as a “LAN-PBX”, is that the telephones can use the same wiring and data switches as the LAN data, thus resulting in increased flexibility and lower cost.

One problem with LAN-PBX type existing systems is that Ethernet cables and switches make no provision for providing power. In Ethernet-based systems, power is provided at each station. As a further complication, Ethernet signals are what are known as “base-band” signals. This means that Ethernet signals include binary data representations that are not frequency shifted. Accordingly, Ethernet signals have frequency components that reach down to almost zero Hertz. For this reason, in existing systems, providing DC power on the same wire as the Ethernet signals is usually infeasible, and could potentially damage the Ethernet devices.

It would therefore be desirable to have a system for providing centrally distributed power to telephone instruments in a LAN-PBX which does not interfere with Ethernet signals also transmitted between an Ethernet switch and the telephone instruments.

### BRIEF SUMMARY OF THE INVENTION

In accordance with principles of the invention, there is disclosed herein a power system for Ethernet LAN appliances, such as telephone instruments. The disclosed system employs two twisted pair wires to provide power to the LAN appliances. In an illustrative embodiment, the two twisted pair wires used to provide the power to the telephone instruments are unused twisted pair wires which may be found in many existing cable bundles. These two twisted pair wires carry DC power from the LAN switch to each LAN appliance. In a first embodiment, the disclosed power system includes a junction box that may be placed in relatively close proximity to an associated enterprise data LAN switch. The junction box is connectable to the LAN switch as well as the LAN appliances. The junction box includes a connection for obtaining external DC power, or alternatively, an internal DC power supply. The disclosed LAN appliances include an internal connection from the two twisted pair wires and their own DC-DC power supplies.

In another illustrative embodiment, a power supply is placed within the LAN switch itself. With this approach, all ports on the switch may employ the previously unused twisted pair wires to supply DC power to LAN appliances. Existing 10megabit and 100megabit LAN adapters for many computer systems make no connection to the unused pair within the cable bundle. Accordingly, such devices would not usually be harmed by the power provided in accordance with the disclosed system.

### BRIEF DESCRIPTION OF THE SEVERAL VIEWS OF THE DRAWING

The invention will be more fully understood by reference to the following detailed description of the invention in conjunction with the drawings, of which:

FIG. 1 shows a high-level block diagram of an embodiment of the disclosed power system using a junction box;

FIG. 2(a) depicts an existing Private Branch Exchange (PBX);

FIG. 2(b) depicts an existing PBX cable frequency plan;

FIG. 2(c) depicts an existing PBX power diplexer filter;

FIG. 3 depicts a schematic for a junction box in accordance with the disclosed LAN power system;

FIG. 4 depicts a physical diagram showing an external power system in accordance with the disclosed system;

FIG. 5 shows a physical depiction of a LAN switch with an internal power system in accordance with the present invention;

FIG. 6 shows a schematic diagram of a power input circuit for a LAN appliance in accordance with an embodiment of the disclosed system;

FIG. 7 shows an existing system using an uninterruptable power supply (UPS); and

FIG. 8 shows an alternative embodiment of the disclosed system in which is illustrated a power supply for the junction box or internal switch power bus.

### DETAILED DESCRIPTION OF THE INVENTION

The disclosures of provisional application serial No. 60/174,674, entitled “LOCAL AREA NETWORK (LAN) PACKET SWITCH REMOTE POWER SYSTEM”, and filed Jan. 6, 2000, to which this application claims priority under 35 USC §119(e), are hereby incorporated by reference herein.

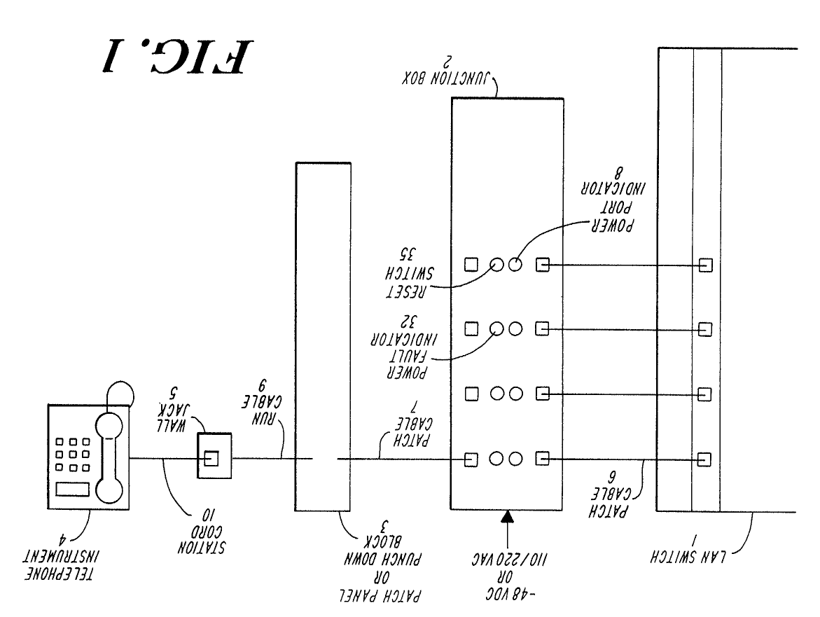

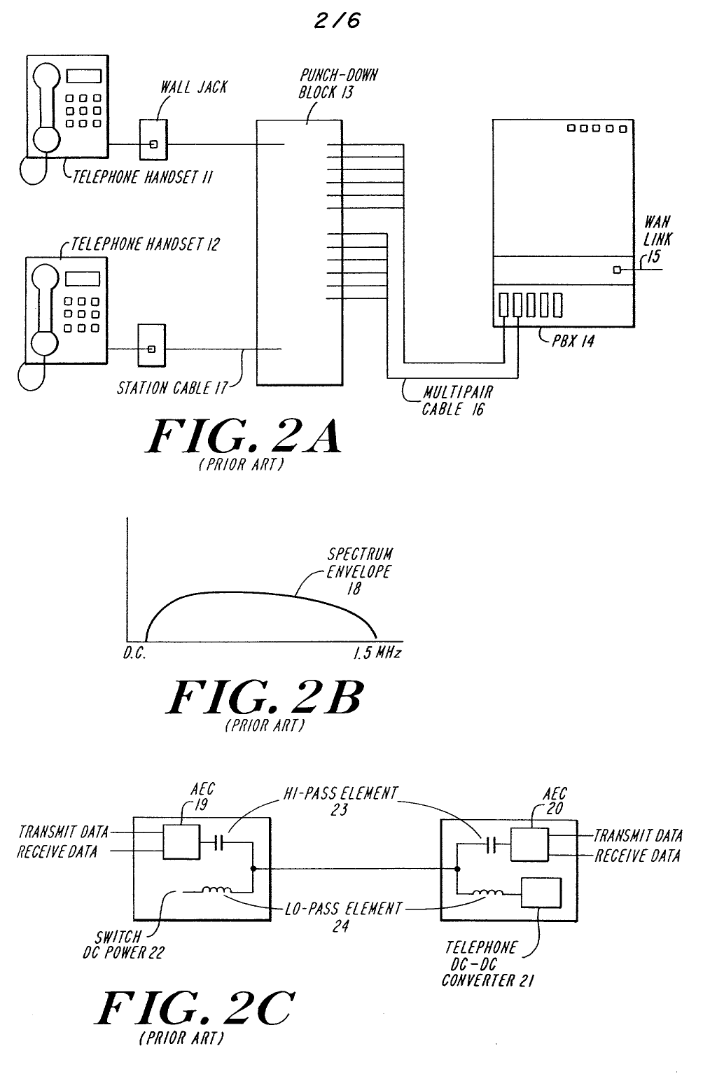

FIG. 1 shows a high-level block diagram of the preferred embodiment. In this diagram, five main components are shown: LAN switch 1, Junction Box 2, Patch Panel 3, Wall Jack 5 and Telephone Instrument 4.

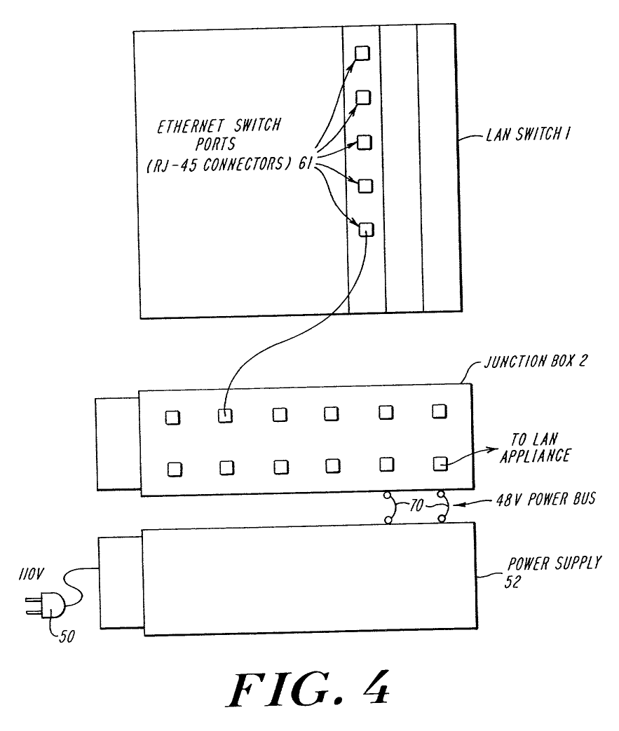

In the illustrative embodiment of FIG. 1, the LAN switch 1 may, for example, consist of a conventional LAN switch or hub. Ordinarily, this device would be directly connected to a patch panel, such as patch panel or punch down block 3, and from there be connected to a computer device. In FIG. 1, the LAN switch 1 is connected from a typical network port to the Junction Box 2, via a standard Patch Cable 6. One patch cable is used for each remote device or telephone, such as the Telephone Instrument 4. The Junction Box 2 injects DC power onto the output Patch Cable 7. The output Patch Cable 7 is used to connect to the Patch Panel 3. The Patch Panel 3 is connected to the Wall Jack 5 via a Run Cable 9. A Station Cord 10 is used to make the connection between the Wall Jack 5 and the Telephone Instrument 4. While the LAN appliance powered by the disclosed system is shown as the Telephone Instrument 4 in the illustrative embodiment of FIG. 4, the disclosed system is not limited in application to this specific type of LAN appliance. Accordingly, those skilled in the art will recognize that the disclosed power distribution system is applicable to any type of LAN appliance, such as, for example, a computer system.

Power enters the Junction Box 2 via an AC or DC Power connection. If an AC power connection is used, then the Junction Box contains a DC power supply. Internal to the Junction Box 2, DC power is applied to the two unused twisted pairs on the connector to the Patch Cable 7 which leads to the Patch Panel 3.

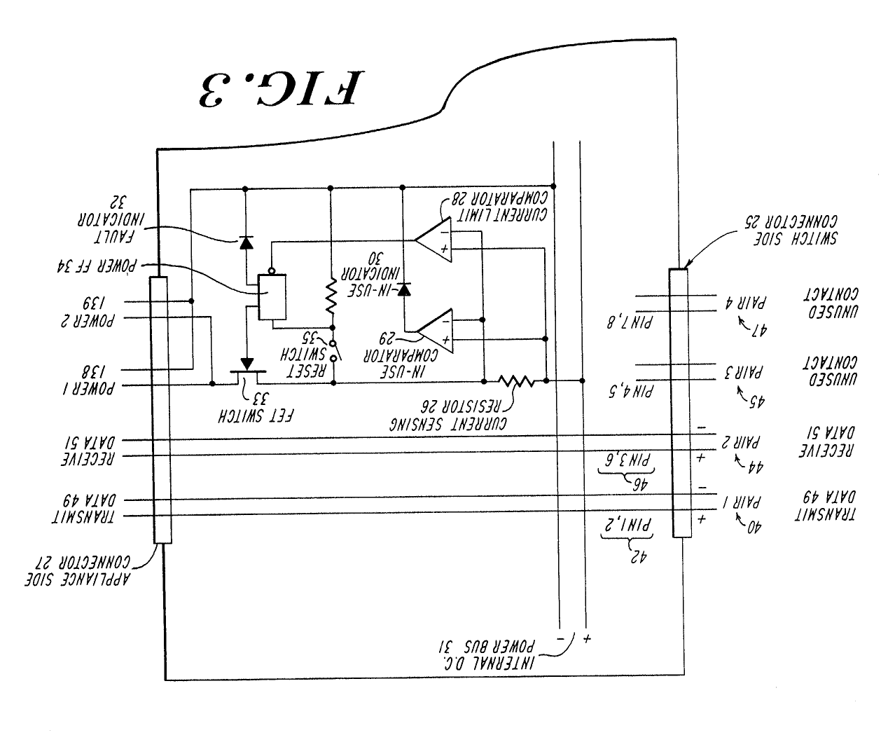

Circuitry inside the Junction Box 2 monitors the current flow on each cable, individually. If the current flow is greater than a predetermined minimum threshold, for example 20 milli-amps, then the Power Port Indicator 8 is activated. This indicates that a LAN telephone or other LAN appliance is connected to the switch. If the current level exceeds a predetermined maximum, for example 500 milli-amps, then the current flow to the appliance via the Patch Cable 7 is interrupted, and the Power Fault Indicator 32 is activated. The current flow to the appliance may be reasserted by operation of a reset switch 35, as shown in FIG. 1 and FIG. 3. Alternatively, the current flow to the appliance may be reasserted under such circumstances by way of a system management program executing on a remote station, from which a command is transmitted to the Junction Box 2 indicating that power to the appliance in question should be reasserted. Such a command may, for example, be provided using a network management protocol such as the Simple Network Management Protocol (SNMP), or through any other appropriate command protocol enabling management of the Junction Box 2 from a remote station. In this way power is regulated to the attached LAN appliances.

Standard data grade cable 6, 7, 9, 10 is typically configured as four twisted pairs, or eight wires. For the disclosed system to be employed, all eight wires must be connected between the Junction Box 2 and the LAN appliance or Telephone Instrument 4, through cables 7, 9, 10 as well as the Patch Panel 3 and Wall Jack 5.

A schematic for an illustrative embodiment of the disclosed Junction Box 2 of FIG. 1 is depicted in FIG. 3. As illustrated in FIG. 3, standard LAN data cable for Ethernet uses only two of the four twisted pairs it contains. As shown in the switch side connector 25 of FIG. 3, twisted pair 1 40, through pins 1 and 2 42, is used to convey Transmit Data from the switch. Twisted pair 2 44, through pins 3 and 6 46, is used for Receive Data. Twisted pairs 3 45 and 4 47 are unused. Pairs 3 45 and 4 47 are not connected on the switch side. The internal DC Power Bus 31 provides to all appliance side connector ports of the Junction Box. For example, the internal power bus 31 is used to provide Power 1 138 and Power 2 139 through two of the twisted pairs connected through the appliance side connector 27. The other two twisted pairs connected through the appliance side connector 27 pass the Transmit Data 49 and Receive Data 51 as also provided on switch side connector 25.

The circuitry of FIG. 3 operates to give indication of proper use and to turn off the power if an over-current condition is detected. A Current Sensing Resistor 26 is used to provide a sense element for detection of conditions Current flowing through the Current Sensing Resistor 26 will develop a voltage that can be used by either or both of the Comparators 28 and 29. The In-Use Comparator 29 will be “off” when no current is flowing in the Current Sensing Resistor 26. When the current is above the minimum threshold, the In-Use Comparator 29 turns “on” , and provides power to the In-Use Indicator 30. This will happen when a minimum current drain appliance is connected to the Appliance side connector 27, via the Patch Cable 7, Patch Panel 3, Run Cable 9, Wall Jack 5 and Station Cord 10, as shown in FIG. 1. The In-Use Indicator 30 if FIG. 3 corresponds to the Power Port Indicator 8 as shown in FIG 1.

If the current passing through the Current Sensing Resistor 26 exceeds a predetermined maximum threshold, then the Current Limit Comparator 28 will turn “on”, causing voltage to be supplied to the Power Control Flip Flop 34, resulting in the Power Control Flip Flop 34 being reset. The output of the Power Control Flip Flop 34 is connected to the FET Switch 33. When the Power Control Flip Flop 34 is reset, then the FET Switch 33 is turned “off” halting current flow to the Appliance Side Connector 27.

When the FET Switch 33 is “off”, the Fault Indicator 32 is activated, thus indicating a fault condition. The indication of a fault condition can be reset by setting the Power Control Flip Flop 34 via momentary connection of the Reset Switch 35. This will cause power to flow again unless the limit is still exceeded.

The circuit of FIG. 3 is replicated for each Appliance Side Connector 27 in the Junction Box 2. In this way each remote appliance has its own power control and fault interruption. This has the advantage of not allowing a fault in one appliance or cable to disrupt operation of the system with regard to other ports of the system.

Referring now to FIG. 4, an external power system in accordance with an illustrative embodiment of the disclosed system is shown. An external AC source 50 (110/120v) is connected to an external power supply 52. External power supply 52 provides appliance power at 48v via power bus 70, which may, for example, consist of twisted pair or any other suitable connection. As further shown in FIG. 4, the LAN Switch 1 includes a number of Ethernet switch ports 61, consisting, for example, of RJ-45 connectors. One of the Ethernet switch ports 61 is shown connected to a switch side connector of the junction box 2, which in turn is shown having a connection to a LAN appliance.

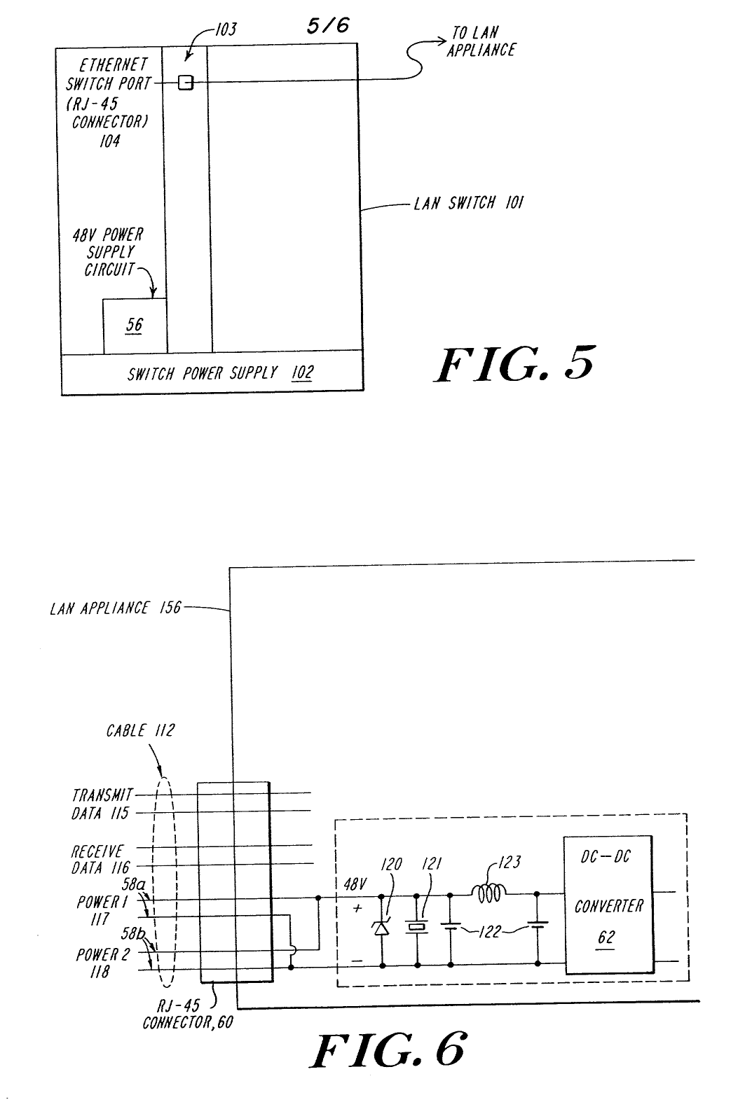

FIG. 5 depicts an embodiment of the disclosed system including an internal power supply 56 contained within a LAN switch 101. The internal power supply 56 is, for example, a 48v power supply circuit, such as would be used to provide power over the power bus 31 in FIG. 3. For example, the power supply circuit 56 may be embodied as shown in the circuit 52 of FIG. 8. The circuitry shown within the Junction Box in FIG. 3 would, accordingly, be included within a circuit board 103 of FIG. 5. A switch power supply 102 is further shown in FIG. 5 providing power to all circuit boards within the switch 101, and/or to the power supply circuit 56. The circuit board 103 is shown including at least one Ethernet Switch port 104, which may be connected to a LAN appliance for purposes of providing data communication and providing power.

FIG. 6 shows an illustrative embodiment. of a 48v power input circuit included within an illustrative embodiment of a LAN appliance 156. The power input circuit of FIG. 6 operates to receive 48v power from twisted pair lines 58a and 58b through a RJ-45connector 60, and to pass the received power as input to a DC-DC converter 62. The output of the DC-DC converter 62 is power for the LAN appliance 156. The cable 112 is shown including twisted pairs for Transmit Data 115, Receive Data 116, Power 1 117 and Power 2 118. The wires within the cable 112 are, for example 24 AWG wires. A smaller gauge wire could be employed alternatively. A zener diode 120 protects against overvoltage. A surge arrester 121, for example a gaseous discharge surge arrester, is employed for surge and static protection. A pair of capacitors 122 located on either side of an inductor 123 are shown as an example of a noise filtering technique that may be employed in connection with the embodiment of FIG. 6. In an alternative embodiment, the DC-DC converter 62 may include the functionality of the other components in the power input circuit shown in FIG. 6.

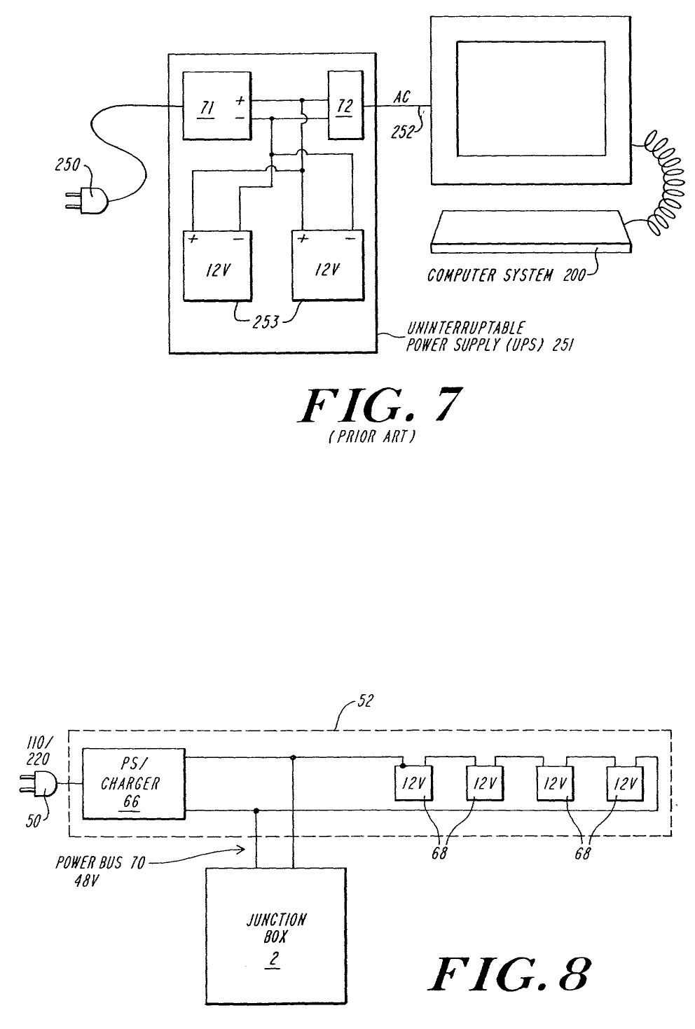

FIG. 7 shows an example of a prior solution to providing power to a computer system 200. As shown in FIG. 7, an Uninterruptable Power Supply (UPS) 251 is used to provide AC power 252 to the network appliance 200, shown for purposes of illustration as a computer system. The UPS 251 is shown including a DC power supply 71 and a DC to AC converter 72, operating in connection with a pair of batteries 253, and a power connector 250. An advantage of the disclosed system is that it may be provisioned centrally, thus obviating the need for power supplies such as the UPS 251 to be located at every LAN appliance. In particular, it should be noted that the disclosed system may be applied to various LAN appliances, including LAN appliances consisting of computer systems having relatively small power requirements.

Referring now to FIG. 8, an embodiment of the external power supply 52 used in the embodiment of FIG. 4 is described. As shown in FIG. 8, AC source 50 provides AC power to the Power Supply/Charger 66. The Power Supply/Charger 66 is shown connected to 48v power bus 70 such that Junction Box 2 may be powered when the AC source 50 is active. A series of four 12v storage cells 68 are also charged when the AC source 50 is active, and supply power to the Junction Box 2 when the AC source 50 is inactive.

While the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

What is claimed is:

1. A junction box, comprising:
at least one switch side connector, said switch side connector including at least one switch side data connection, said at least one switch side data connection having contacts operable to convey data, and at least one unused switch side connection, said at least one unused switch side connection having no contacts;
at least one appliance side connector, said appliance side connector including at least one appliance side data connection, said at least one appliance side data connection having contacts operable to convey data, wherein said at least one appliance side data connection is coupled to said at least one switch side data connection, and at least one appliance side power connection, said at least one appliance side power connection corresponding to said at least one unused switch side connection; and
a circuit for supplying power, said circuit for supplying power coupled to said at least one appliance side power connection.

2. The junction box of claim 1, wherein said at least one switch side data connection comprises a switch side transmit data connection and a switch side receive data connection, and wherein said at least one appliance side data connection comprises a first appliance side data connection coupled to said switch side receive data connection and a second appliance side data connection coupled to said switch side transmit data connection.

3. The junction box of claim 2, wherein said circuit for supplying power further comprises an in-use indicator, said in-use indicator operable to provide indication that an appliance is connected to said at least one appliance side connector.

4. The junction box of claim 3, wherein said circuit for supplying power further comprises a fault indicator, said fault indicator operable to provide indication that a current flow on said at least one appliance side power connection exceeds a predetermined maximum level.

5. The junction box of claim 4, further comprising circuitry operable to disconnect said circuit for supplying power from said at least one appliance side power connection in the event that no appliance is connected to said at least one appliance side connector.

6. The junction box of claim 4, further comprising circuitry operable to disconnect said circuit from supplying power from said at least one appliance side power connection in the event that said current level on said at least one appliance side power connection exceeds said predetermined maximum level.

7. A packet switch, comprising:
at least one appliance connector, said appliance connector including at least one data connection, said at least one data connection having contacts operable to convey data to and from a corresponding appliance coupled to said packet switch, said appliance connector further including at least one power connection; and
a circuit for supplying power, said circuit for supplying power coupled to said at least one power connection.

8. The packet switch of claim 7, wherein said at least one data connection comprises a transmit data connection and a receive data connection.

9. The packet switch of claim 8, wherein said circuit for supplying power further comprises an in-use indicator, said in-use indicator operable to provide indication that an appliance is connected to said at least one appliance connector.

10. The packet switch of claim 9, wherein said circuit for supplying power further comprises a fault indicator, said fault indicator operable to provide indication that a current flow on said at least one power connection exceeds a predetermined maximum level.

11. The packet switch of claim 10, further comprising circuitry operable to prevent said circuit for supplying power from supplying power to said at least one power connection in the event that said current flow on said at least one power connection exceeds said predetermined maximum level.

12. A telephone appliance, comprising:
a switch connector, said switch connector including at least one data connection, said data connection operable to receive and transmit data with respect to a switch coupled to said telephone appliance, and wherein said switch connector further includes at least one power connector operable to receive power from said switch coupled to said telephone appliance.
